(19) United States
(12) Patent Application Publication
(10) Pub. No.: US 2025/0251837 A1
(43) Pub. Date: Aug. 7, 2025

(54) TOUCH PANEL AND DISPLAY DEVICE

(71) Applicants: Yungu (Gu’an) Technology Co., Ltd., Langfang (CN); Visionox Technology Inc., Kunshan (CN)

(72) Inventors: Xinglong HE, Langfang (CN); Kun HE, Langfang (CN)

(73) Assignees: Yungu (Gu’an) Technology Co., Ltd., Langfang (CN); Visionox Technology Inc., Kunshan (CN)

(21) Appl. No.: 19/186,628

(22) Filed: Apr. 23, 2025

Related U.S. Application Data
(63) Continuation of application No. PCT/CN2023/126924, filed on Oct. 26, 2023.

(30) Foreign Application Priority Data
Oct. 27, 2022 (CN) 202211330324.2
Nov. 2, 2022 (CN) 202211362044.X

(51) Int. Cl. G06F 3/044

(52) U.S. Cl. CPC G06F 3/0446; G06F 3/0448; G06F 2203/04107; G06F 2203/04111; G06F 2203/04112

(57) ABSTRACT

The present application relates to the field of display and provides a touch panel and a display device intended to solve the problem of a touch panel being prone to touch insensitivity and random response errors. The touch panel includes a substrate and touch units. The plurality of touch units are arranged in an array on the substrate, and each of the touch units includes a first touch electrode and at least one second touch electrode insulated from each other. In the same touch unit, an isolation gap is formed between the first touch electrode and the second touch electrode, a floating electrode is provided in at least part of the isolation gap, and the floating electrode is insulated from both the first touch electrode and the second touch electrode. The touch panel and the display device according to the present application are used to implement touch and display functions.

The present application is a continuation of International Application No. PCT/CN 2023/126924 filed on Oct. 26, 2023, which claims priorities to Chinese Patent Application No. 202211330324.2 filed with the China National Intellectual Property Administration on Oct. 27, 2022 and entitled “TOUCH PANEL AND DISPLAY DEVICE” and Chinese Patent Application No. 202211362044.X filed with the China National Intellectual Property Administration on Nov. 2, 2022 and entitled “TOUCH UNIT AND TOUCH PANEL”, which are incorporated herein by reference in its entirety.

### FIELD

The present application relates to the field of display, and in particular to a touch panel and a display device.

### BACKGROUND ART

Capacitive touch panels are widely used in a variety of electronic interaction scenario devices thanks to their advantages of durability, long service life, and being multi-touch enabled.

The operating principles of the capacitive touch panels are based on detecting fluctuations of a coupling capacitance between touch electrodes to sense touch actions. The coupling capacitance includes a proximal capacitance and a distal capacitance. The change in dielectric coefficient of a capacitive touch panel has a greater impact on the proximal capacitance and a smaller impact on the distal capacitance.

When a user's touch action ends, the dielectric coefficient changes at the touched position under the action of the temperature of the finger to cause a large fluctuation in the proximal capacitance and in turn affect the detection accuracy of the coupling capacitance between the touch electrodes, causing the problem of touch insensitivity and random response errors of the capacitive touch panel.

### SUMMARY OF THE DISCLOSURE

In view of the above problem, the embodiments of the present application provide a touch panel and a display device, which can reduce the impact of the change in dielectric coefficient on a coupling capacitance between touch electrodes to improve the detection accuracy of the coupling capacitance, to avoid touch insensitivity and random response errors of the touch panel.

In order to achieve the above objective, the following solutions are provided according to the embodiments of the present application.

In a first aspect of the embodiments of the present application, a touch panel is provided. The touch panel includes a substrate and a plurality of touch units. The plurality of touch units are arranged in an array on the substrate, and each of the touch units includes a first touch electrode and at least one second touch electrode insulated from each other. In the same touch unit, an isolation gap is formed between the first touch electrode and the second touch electrode, a floating electrode is provided in at least part of the isolation gap, and the floating electrode is insulated from both the first touch electrode and the second touch electrode.

In the touch panel according to the embodiments of the present application, the touch unit includes a first touch electrode and a second touch electrode insulated from each other, a floating electrode is provided in an isolation gap between the first touch electrode and the second touch electrode, and the floating electrode is insulated from both the first touch electrode and the second touch electrode. This arrangement can increase the gap between the first touch electrode and the second touch electrode.

In the related art, the gap between the first touch electrode and the second touch electrode is small, resulting in a larger proximal capacitance and a smaller distal capacitance between the first touch electrode and the second touch electrode. When the dielectric coefficient of the touch panel is affected by a temperature change, the proximal capacitance fluctuates greatly due to the temperature change, resulting in a large fluctuation in the coupling capacitance of the entire touch panel due to the temperature change to affect the detection accuracy of the coupling capacitance between the touch electrodes, to affect the normal operation of the touch panel.

However, in the touch panel according to the embodiments of the present application, an isolation gap is formed between the first touch electrode and the second touch electrode to increase the distance between the first touch electrode and the second touch electrode, to reduce the proximal capacitance between the first touch electrode and the second touch electrode and increase the distal capacitance. Accordingly, the fluctuation in the proximal capacitance due to a temperature change can be reduced, and the touch function of the touch panel is less affected by the temperature change to avoid touch insensitivity and random response errors of the touch panel, thereby ensuring the normal operation of the touch panel.

Further, according to the embodiments of the present application, while increasing the isolation gap between the first touch electrode and the second touch electrode, the floating electrode is disposed in the isolation gap, and the proximal capacitance between the first touch electrode and the second touch electrode is further reduced by means of the shielding effect of the floating electrode; and the floating electrode can provide a uniform visual effect on the isolation gap to prevent the large isolation gap from being visible, thereby improving the display uniformity effect.

In a second aspect of the embodiments of the present application, a display device is provided. The display device includes a touch panel described in the first aspect. That is, the display device includes a touch unit described above. Using the touch unit can ensure the stability of the touch function of the display device under conditions of large temperature difference, thereby improving the user experience and product market competitiveness.

### BRIEF DESCRIPTION OF THE DRAWINGS

To describe the embodiments of the present application or in the related art more clearly, the drawings required for the descriptions of the embodiments or the related art will be described briefly below. Apparently, the drawings in the following descriptions are illustrated for some of the embodiments of the present application, and other drawings can be obtained from these drawings.

FIG. 1 is a schematic diagram showing the principles of a capacitive touch panel in the related art;

FIG. 2 is a schematic diagram showing the distribution of electrodes of a touch unit in the related art;

FIG. 3 is a top view of a touch panel according to a first embodiment of the present application;

FIG. 4 is a schematic diagram showing the arrangement of electrodes of a touch unit according to the first embodiment of the present application;

FIG. 5 is a schematic enlarged view of part A in FIG. 4;

FIG. 6 is a schematic diagram showing boundaries between a first touch electrode and a second touch electrode located in the same touch unit according to the first embodiment of the present application;

FIG. 7 is a schematic diagram showing the arrangement of a floating electrode between the first touch electrode and the second touch electrode according to the first embodiment of the present application;

FIG. 8 is a schematic diagram showing the arrangement of electrodes of a touch unit according to a second embodiment of the present application;

FIG. 9 is a schematic diagram of a structure of a first touch electrode in FIG. 8;

FIG. 10 is a schematic diagram of a structure of a second touch electrode in FIG. 8;

FIG. 11 is a schematic enlarged view of an electrode overlapping portion in FIG. 10; and

FIG. 12 is a schematic diagram showing some dimensions of the touch electrodes in FIG. 8.

### DETAILED DESCRIPTION OF EMBODIMENTS

As described in the background art, a touch panel in the related art is prone to touch insensitivity and random response errors. The applicant has found through research that the reason for this problem is that the operating principles of a capacitive touch screen are based on detecting fluctuations of a coupling capacitance between touch electrodes to sense touch actions.

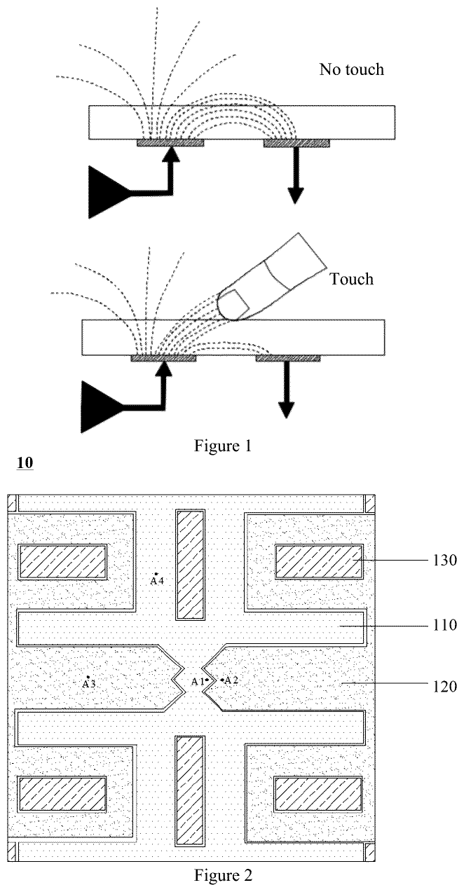

As shown in FIG. 1, when no finger touches the touch panel, there is a fixed coupling capacitance Cm between a driving touch electrode and a sensing touch electrode, and in this case the distribution of an electric field between the electrodes is fixed. When a finger touches the touch panel, the electric field between the driving touch electrode and the sensing touch electrode changes, causing the decrease in the coupling capacitance Cm. When the touch panel detects the decreased coupling capacitance Cm, it will determine that there is a finger touch and then a touch operation is fed back.

As shown in FIG. 2, a touch unit 10 includes a first touch electrode 110, a second touch electrode 120 and a floating electrode 130 (a Dummy electrode). The first touch electrode 110, the second touch electrode 120 and the floating electrode 130 are insulated from each other. The floating electrode 130 is disposed in punched regions of the first touch electrode 110 and punched regions of the second touch electrode 120.

The inventors analyzed the touch insensitivity caused by the temperature difference described above and found that the coupling capacitance Cm is mainly composed of a proximal capacitance Cm1 and a distal capacitance Cm2. The proximal capacitance Cm1 is generated between portions of the first touch electrode 110 and the second touch electrode 120 closer to each other, such as point A1 and point A2 in FIG. 2. The distal capacitance Cm2 is generated between portions of the first touch electrode 110 and the second touch electrode 120 farther away from each other, such as point A3 and point A4 in FIG. 2. Since the dielectric coefficient of the capacitive touch panel is sensitive to a temperature change, a slight change in the dielectric coefficient will cause a larger fluctuation in the proximal capacitance and a smaller impact on the distal capacitance.

When no finger touches a screen, the dielectric for the distal capacitance is mainly the air outside the screen, and the dielectric for the proximal capacitance is mainly the screen material. When a finger touches the screen, the temperature of the screen material changes, and after the finger leaves the screen, the temperature of the screen material cannot return immediately, causing the dielectric coefficient of the proximal capacitance to be affected greatly by temperature.

For example, when the screen is at a high temperature, two effects are superimposed on the coupling capacitance when a finger touches the screen. On the one hand, when the finger approaches the screen, the coupling capacitance can decrease. On the other hand, heat is absorbed away from the touched position such that the temperature at the touched position decreases, which in turn reduces the dielectric coefficient of the screen material and the proximal capacitance.

In this case, the temperature difference has a positive effect on the touch and will cause no touch problems. However, when the finger is lifted and leaves the touched position, the temperature of the original touched position will not return immediately. In this case, the decreased proximal capacitance remains than before the touch, and then there is still a response to the touch action at the original touched position after the finger is lifted, which in turn affects the detection accuracy of the coupling capacitance between the touch electrodes, and the touch panel is prone to random response errors.

Also, when the screen is at a low temperature, two effects are superimposed on the coupling capacitance when a finger touches the screen. On the one hand, when the finger approaches the screen, the coupling capacitance can decrease. On the other hand, the heat of the finger is absorbed at the touched position such that the temperature at the touched position increases, which in turn increases the dielectric coefficient of the screen material and the proximal capacitance. In this case, the temperature difference has a reverse effect on the touch, and when the magnitude of increase in the proximal capacitance caused by the temperature difference is greater than or equal to the magnitude of decrease in the capacitance caused by the finger touch, there is no response to touch.

Accordingly, during a finger touch operation on the touch panel, the temperature change causes the change in dielectric coefficient of the screen material, resulting in a larger fluctuation in the proximal capacitance, which affects the detection accuracy of the coupling capacitance between the touch electrodes, and the touch panel is prone to touch insensitivity and random response errors.

In response to the above problem, the embodiments of the present application provide a touch panel and a display device. An isolation gap is formed between a first touch electrode and a second touch electrode, and a floating electrode is provided in the isolation gap, and the distance between the first touch electrode and the second touch electrode can be increased, to reduce the proximal capacitance between the first touch electrode and the second touch electrode and increase the distal capacitance.

Further, the proximal capacitance between the first touch electrode and the second touch electrode is further reduced by means of the shielding effect of the floating electrode. In this way, the fluctuation in the proximal capacitance due to a temperature change can be reduced, and the touch function of the touch panel is less affected by the temperature change to avoid touch insensitivity and random response errors of the touch panel, thereby ensuring the normal operation of the touch panel.

To make the above objective, features and advantages of the embodiments of the present application clearer and easier to understand, the embodiments of the present application will be clearly and completely described below with reference to the drawings in the embodiments of the present application. Apparently, the embodiments as described are merely some rather than all of the embodiments of the present application.

The display device according to the embodiments of the present application includes a touch panel, a display screen, an optical adhesive layer, a cover plate, etc. The touch panel is disposed on a light-emitting side of the display screen, the optical adhesive layer is disposed between the cover plate and the touch panel, and the cover plate and the touch panel are bonded together by means of the optical adhesive layer.

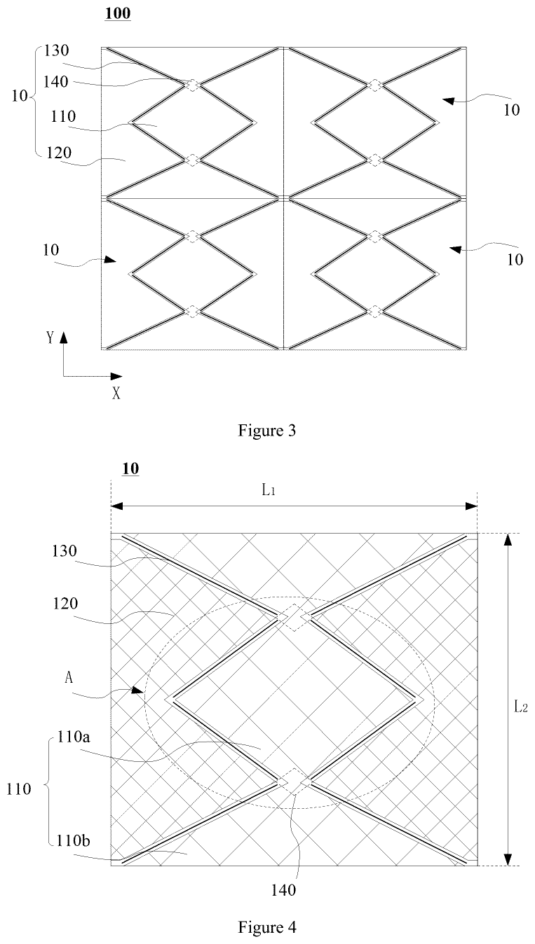

As shown in FIG. 3, the touch panel 100 according to the embodiments of the present application includes a substrate and a plurality of touch units 10 disposed on the substrate. The plurality of touch units 10 are arranged in an array on the substrate. For ease of description of the embodiments of the present application, the X-direction shown in FIG. 3 is a first direction, and the Y-direction is a second direction.

As shown in FIG. 4, the touch unit 10 according to the embodiments of the present application includes a first touch electrode 110 and at least one second touch electrode 120 insulated from each other. The first touch electrode 110 and the second touch electrode 120 may be disposed in the same layer or in different layers. The first touch electrode 110 may be a driving electrode, and the second touch electrode 120 may be a sensing electrode; or the first touch electrode 110 may be a sensing electrode, and the second touch electrode 120 may be a driving electrode. This is not limited in the embodiments of the present application.

In the embodiments of the present application, an isolation gap is formed between the first touch electrode 110 and the second touch electrode 120, and floating electrode 130 is provided in at least part of the isolation gap. In one embodiment, a floating electrode 130 is provided in the isolation gap between the first touch electrode 110 and the second touch electrode 120, and the floating electrode 130 is disposed in the same layer as at least one of the first touch electrode 110 and the second touch electrode 120. For example, the floating electrode 130 is disposed in the same layer as the first touch electrode 110 and the second touch electrode 120.

In some embodiments, in the same touch unit 10, an isolation gap is formed between the first touch electrode 110 and the second touch electrode 120, and two side edges of the isolation gap form boundaries 50 with the first touch electrode 110 and the second touch electrode 120, respectively. That is, the first touch electrode 110 and the second touch electrode 120 are insulated from each other by the isolation gap.

The floating electrode 130 is disposed in the isolation gap, and an extension direction of the floating electrode 130 is consistent with an extension direction of the boundaries 50. That is, the floating electrode 130 is disposed parallel to the boundaries 50. The floating electrode 130 forms insulation gaps greater than or equal to 5 μm and less than or equal to 10 μm with the first touch electrode 110 and the second touch electrode 120, respectively, in an extension direction perpendicular to the boundaries 50. By providing the insulation gaps, the floating electrode 130 is insulated from both the first touch electrode 110 and the second touch electrode 120.

In one embodiment, a width of the floating electrode 130 may be greater than or equal to 80 μm and less than or equal to 120 μm in the extension direction perpendicular to the boundaries 50. By setting a larger width of the floating electrode 130, the distance between the first touch electrode 110 and the second touch electrode 120 is increased, to reduce the proximal capacitance.

In this way, according to the embodiments of the present application, providing the isolation gap between the first touch electrode 110 and the second touch electrode 120 can significantly increase the distance between the first touch electrode 110 and the second touch electrode 120 to reduce the proximal capacitance. In addition, the floating electrode 130 can also achieve a uniform visual effect on the isolation gap to prevent the large isolation gap from being visible, thereby improving the display uniformity effect. The proximal capacitance between the first touch electrode 110 and the second touch electrode 120 is further reduced by means of the shielding effect of the floating electrode 130.

In the related art, an insulation gap of 5 μm to 10 μm is formed between the first touch electrode 110 and the second touch electrode 120, resulting in a larger proximal capacitance and a smaller distal capacitance between the first touch electrode 110 and the second touch electrode 120. When the dielectric coefficient of the touch panel is affected by a temperature change, the proximal capacitance is affected greatly due to the temperature change, resulting in a large fluctuation in the coupling capacitance of the entire touch panel 100 due to the temperature change to affect the detection accuracy of the coupling capacitance between the touch electrodes, to affect the normal operation of the touch panel 100.

In the touch panel 100 according to the embodiments of the present application, an isolation gap is formed between the first touch electrode 110 and the second touch electrode 120 to increase the distance between the first touch electrode 110 and the second touch electrode 120, to reduce the proximal capacitance between the first touch electrode 110 and the second touch electrode 120 and increase the distal capacitance increases.

Further, the proximal capacitance between the first touch electrode 110 and the second touch electrode 120 is further reduced by means of the shielding effect of the floating electrode 130. Accordingly, the fluctuation in the proximal capacitance due to a temperature change can be reduced, and the touch function of the touch panel 100 is less affected by the temperature change to avoid touch insensitivity and random response errors of the touch panel 100, thereby ensuring the normal operation of the touch panel 100.

In the embodiments of the present application, the floating electrode 130 may be disposed only in at least part of the region between the first touch electrode 110 and the second touch electrode 120. Compared with the related art, the absence of punched regions in the first touch electrode 110 and the second touch electrode 120 for the arrangement of the floating electrode 130 can increase the distal capacitance, and can ensure that the overall induction of the coupling capacitance Cm changes a little during the touch.

The inventors further found that the proportion of the adjacent edges between the first touch electrode 110 and the second touch electrode 120 is associated with the proximal capacitance. The proportion of the adjacent edges refers to a ratio of a length of the adjacent edges to the sum of lengths of all the edges of the touch electrodes. Referring to FIG. 2 again, in the related art, since the proportion of the adjacent edges between the first touch electrode 110 and the second touch electrode 120 is large, the proximal capacitance is large, and the amount of change in the coupling capacitance Cm due to the temperature difference is also large, easily causing touch insensitivity.

To this end, in the embodiments of the present application, the shapes of the touch electrodes of the touch unit are changed accordingly to reduce the proportion of the adjacent edges between the first touch electrode 110 and the second touch electrode 120 and in turn reduce the proximal capacitance. In the embodiments of the present application, the touch unit has touch electrodes of different shapes. The different arrangements of the touch electrodes in the touch unit are described in detail below in different embodiments.

### First Embodiment

As shown in FIGS. 3 to 6, each touch unit 10 includes two second touch electrodes 120 arranged in a first direction and a first touch electrode 110 arranged in a second direction. The first touch electrode 110 is disposed between the two second touch electrodes 120 in the first direction.

Specifically, in this embodiment of the present application, in the same touch unit 10, the two second touch electrodes 120 are respectively disposed on two sides of the first touch electrode 110 in the first direction X. That is, the second touch electrodes 120 are arranged in the first direction X on the two sides of the first touch electrode 110.

In one embodiment, the first touch electrode 110 includes a first electrode region 110a and two second electrode regions 110b. The two second electrode regions 110b are respectively located on the two sides of the first electrode region 110a in the second direction Y. That is, the first electrode region 110a is disposed between the two second electrode regions 110b. It should be noted that the first direction X intersects with the second direction Y. For example, the first direction X is perpendicular to the second direction Y. In one embodiment, the first touch electrode 110 is funnel shaped.

In one embodiment, a floating electrode 130 is provided in an isolation gap between the first electrode region 110a and the second touch electrode 120, and/or a floating electrode 130 is provided in an isolation gap between the second electrode region 110b and the second touch electrode 120. In one embodiment, the floating electrode 130 is provided in the isolation gaps between the first electrode region 110a and the second touch electrode 120 and between the second electrode region 110b and the second touch electrode 120. In this way, the proximal capacitance between the second touch electrode 120 and the first touch electrode 110 can be further reduced.

In this embodiment of the present application, the first electrode region 110a and the second electrode region 110b respectively form isolation gaps with the second touch electrode 120. In other words, the isolation gaps are respectively formed at the boundary regions between the first electrode region 110a and the second touch electrode 120 and between the second electrode region 110b and the second touch electrode 120, the floating electrode 130 is disposed in the isolation gaps, and a certain insulation gap remains between the floating electrode 130 and the second touch electrode 120 to insulate the floating electrode from the first touch electrode 110.

For example, in the same touch unit 10, the size of the first electrode region 110a in the first direction X increases and then decreases in the second direction Y; and the size of the second electrode region 110b in the first direction X gradually decreases in a direction from the second electrode region 110b to the first electrode region 110a.

For example, in this embodiment of the present application, the first electrode region 110a is rhombic, circular or elliptical, and the second electrode region 110b is triangular, which will not be limited in this embodiment of the present application. This embodiment of the present application is illustrated by taking the first electrode region 110a being rhombic and the second electrode region 110b being triangular as an example.

In one embodiment, the two second electrode regions 110b located in the same touch unit 10 are symmetrically arranged on two sides of the first electrode region 110a in the second direction Y. The first electrode region 110a is rhombic, the second electrode regions 110b are located on either side of the first electrode region 110a and are triangular, and the first electrode region 110a is in communication with the second electrode regions 110b; and the second touch electrode 120 and the first touch electrode 110 form M-shaped boundaries 50 with two side edges of the isolation gap, respectively. In one embodiment, the second touch electrode 120 is M-shaped.

As shown in FIG. 4, for ease of description of this embodiment of the present application, the M-shaped boundary 50 formed by the second touch electrode 120 and the isolation gap includes a first border 151, a second border 152, a third border 153 and a fourth border 154 which are connected in sequence in the second direction. The second border 152 and the third border 153 are opposite to the first electrode region 110a via the isolation gap; and the first border 151 and the fourth border 154 are respectively opposite to the two second electrode regions 110b via the isolation gaps.

An orthographic projection of an edge contour of the first electrode region 110a on the substrate is rhombic. That is, the first electrode region 110a is a rhombic region. The two edges of the first electrode region 110a on the same side are opposite to the second border 152 and the third border 153 via the isolation gap in the first direction X.

An orthographic projection of the second electrode region 110b on the substrate is triangular. That is, the second electrode region 110b is a triangular region. The oblique edge of the second electrode region 110b on one side of the first electrode region 110a in the second direction is opposite to the first border 151 in the M-shaped boundary 50 via the isolation gap; and the oblique edge of the second electrode region 110b on the other side of the first electrode region 110a is opposite to the fourth border 154 of the M-shaped boundary 50 via the isolation gap.

In this way, in the case of the same touch area of the touch unit 10, compared with the U-shaped boundary between the second touch electrode 120 and the first touch electrode 110 in the related art, the M-shaped boundaries formed between the second touch electrode 120 and the edge of the isolation gap and between the first touch electrode 110 and the edge of the isolation gap can reduce the coupling area between the second touch electrode 120 and the first touch electrode 110, which in turn reduces the proximal capacitance between the second touch electrode 120 and the first touch electrode 110, to reduce the impact of a temperature change on the normal operation of the touch panel 100.

In one embodiment, in the same touch unit 10, a bridge (bridging member) 140 connecting the two second touch electrodes 120 is provided at a connection between the first electrode region 110a and the second electrode region 110b. In the same touch unit 10, two bridges 140 are provided between the two second touch electrodes 120, and the bridges 140 are respectively disposed between vertices, close to each other, of the M-shaped boundaries 50 of the two second touch electrodes 120, and two ends of each bridge 140 are respectively connected to the two second touch electrodes 120. That is, the two second touch electrodes 120 are bridged by the bridge 140.

In one embodiment, a first vertex 155 is formed between the first border 151 and the second border 152, and a second vertex 156 is formed between the third border 153 and the fourth border 154. In one embodiment, the two second touch electrodes 120 located in the same touch unit 10 are symmetrically arranged on two sides of the first touch electrode 110 in the first direction X. The two second touch electrodes 120 are symmetrically arranged with respect to the first touch electrode 110, and each of the two second touch electrodes 120 forms an M-shaped boundary 50 on a side facing the first touch electrode 110.

In the same touch unit 10, one bridge 140 is arranged between first vertices 155, opposite to each other in the first direction X, of the M-shaped boundaries of the two second touch electrodes 120, and one bridge 140 is arranged between second vertices 156, opposite to each other in the first direction X, of the M-shaped boundaries of the two second touch electrodes 120. In the same touch unit 10, one of the bridges 140 described above is disposed between the two first vertices 155, the other bridge 140 is disposed between the two second vertices 156, and two ends of each bridge 140 are respectively connected to the two second touch electrodes 120.

In other words, the first electrode region 110a is connected to the second electrode regions 110b, one of the bridges 140 may be disposed at the connection between the first electrode region 110a and the second electrode region 110b that is located on one side thereof, and the other bridge 140 may be disposed at a connection between the second electrode region 110b and the second electrode region 110b that is located on the other side thereof. In this way, the two second touch electrodes 120 are connected via the two bridges 140, which can reduce the resistance between the second touch electrodes 120.

It should be noted that the touch panel 100 may include an underlying metal layer, an insulating layer (e.g., an optical adhesive layer) and a patterned metal layer. The bridges 140 may be formed on the underlying metal layer, the second touch electrode 120 and the first touch electrode 110 may be formed on the patterned metal layer, the patterned metal layer is located above the underlying metal layer, a through hole is formed in the insulating layer at a bridging position, and the patterned metal layer and the underlying metal layer are connected via a conductive structure in the through hole, thereby achieving bridging.

In the same touch unit 10, each second touch electrode 120 may be a mesh electrode, and/or each first touch electrode 110 may be a mesh electrode, and/or each floating electrode 130 may be a mesh electrode, which can avoid shielding a display light-emitting unit of the display screen to avoid affecting the display. The second touch electrodes 120, the first touch electrode 110 and the floating electrode 130 may have the same or different mesh sizes.

In this embodiment of the present application, a length e of the bridge 140 in the first direction may be greater than or equal to 200 μm and less than or equal to 300 μm, which can avoid the increase in the proximal capacitance between the second touch electrode 120 and the first touch electrode 110 due to too small spacing between the two second touch electrodes 120, and can also avoid the increase in the on-resistance between the first electrode region 110a and the second electrode region 110b due to too small connection region between the first electrode region 110a and the second electrode region 110b.

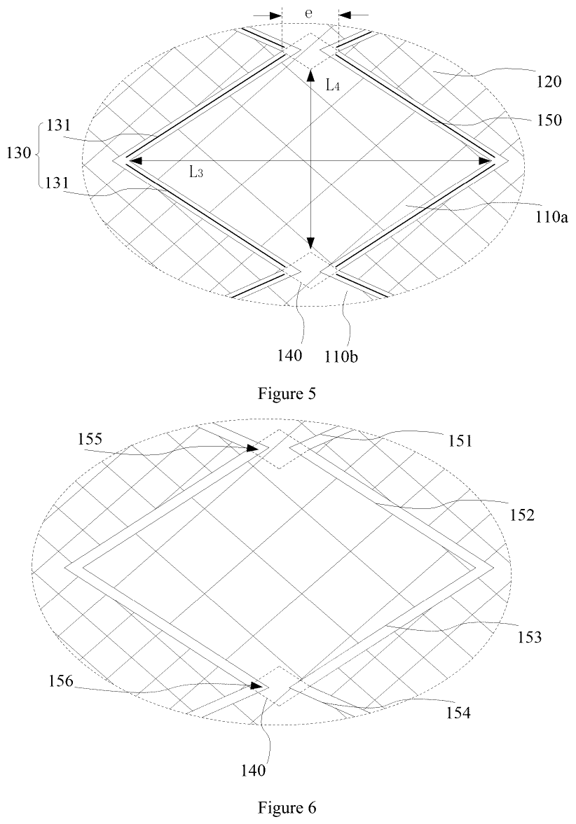

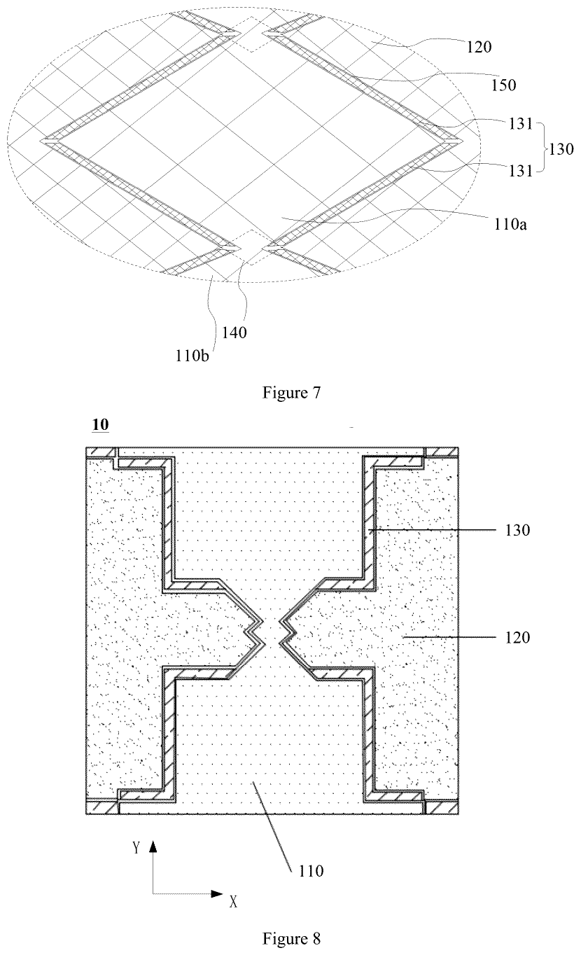

Referring to FIGS. 5 and 7, on the basis of the embodiment described above, in the same touch unit 10, the floating electrode 130 between the first touch electrode 110 and at least one second touch electrode 120 (e.g., the first touch electrode 110 and any of the second touch electrodes 120) includes a plurality of sub-electrodes 131, and the plurality of sub-electrodes 131 are arranged in sequence and spaced apart from each other in an extension direction of the boundaries 50.

In one embodiment, the floating electrode 130 is arranged in the extension direction of the M-shaped boundary 50, and the floating electrode 130 includes a plurality of sub-electrodes 131. The M-shaped boundary 50 includes four continuous borders, i.e., a first border 151, a second border 152, a third border 153 and a fourth border 154.

For example, the floating electrode 130 includes four sub-electrodes 131. Each sub-electrode 131 is arranged in the extension direction of the corresponding border, and two adjacent sub-electrodes 131 may be disconnected at the vertex of the borders. That is, the two adjacent sub-electrodes 131 are disconnected to maintain a spacing.

In this way, compared with providing a continuous floating electrode 130 between the second touch electrode 120 and the first touch electrode 110, in the case where the floating electrode 130 is configured to have a plurality of sub-electrodes 131, when the floating electrode 130 is affected by an interference signal, each sub-electrode 131 has a small impact on the proximal capacitance between the second touch electrode 120 and the first touch electrode 110, thereby improving the detection accuracy of the coupling capacitance of the touch panel 100.

In this embodiment of the present application, the first border 151, the second border 152, the third border 153 and the fourth border 154 are each configured as a straight line segment, one sub-electrode 131 is provided on one side of each of the borders, and each sub-electrode 131 is configured as a linear electrode. That is, an orthographic projection of each border on the substrate is a line segment, and accordingly, each sub-electrode 131 of the floating electrode 130 is configured as a linear electrode with a certain width. Further, each sub-electrode 131 forms certain insulation gaps with the second touch electrode 120 and the first touch electrode 110.

In this way, in the case of the same boundary length, compared with the wavy or zigzag orthographic projection of the boundary in the related art, each border being configured as a straight line segment in this embodiment of the present application can reduce the coupling area between the second touch electrode 120 and the first touch electrode 110, and in turn reduce the proximal capacitance between the second touch electrode 120 and the first touch electrode 110, to reduce the impact of a temperature change on the normal operation of the touch panel 100.

It should be noted that each sub-electrode 131 may be a linear conductor disposed in the insulation gap to form a linear electrode. For example, the sub-electrode 131 may be a straight metal wire. In one embodiment, as shown in FIG. 5, each sub-electrode 131 may be a grid conductor disposed in an isolation gap to form a mesh electrode. For example, the sub-electrode 131 may be a mesh metal wire. In this way, the sub-electrodes 131, the second touch electrode 120 and the first touch electrode 110 are all mesh electrodes to facilitate manufacturing.

Continuing to refer to FIGS. 4 and 5, on the basis of the embodiment described above, a ratio L1/L2 of an extension length L1 of each touch unit 10 in the first direction to an extension length L2 of the touch unit 10 in the second direction is greater than or equal to 0.95 and less than or equal to 1.05. That is, the extension length L1 of the touch unit 10 in the first direction X (the maximum size in the first direction X) is approximately equal to the extension length L2 of the touch unit 10 in the second direction Y (the maximum size in the second direction Y). The touch unit 10 may be rectangular, for example, square.

In one embodiment, a length L3 of the first electrode region 110a is greater than or equal to 0.6L1 and less than or equal to 0.7L1 in the first direction X. L1 is the extension length of the touch unit 10 in the first direction X. By increasing the size of the first electrode region 110a in the first direction X to increase the area of the first electrode region 110a to increase the distal capacitance, the impact of a temperature change on the touch function is reduced.

In one embodiment, a length L4 of the first electrode region 110a is greater than or equal to 0.4L2 and less than or equal to 0.6L2 in the second direction Y. L2 is the extension length of the touch unit 10 in the second direction Y. By increasing the size of the first electrode region 110a in the second direction Y to increase the area of the first electrode region 110a to increase the distal capacitance, the impact of a temperature change on the touch function is reduced. In one embodiment, the length L4 of the first electrode region 110a is equal to 0.5L2 in the second direction Y.

In this way, in the same touch unit 10, an orthographic projection area of all the second touch electrodes 120 on the substrate is greater than or equal to 45% of the area of the entire touch unit 10 and less than or equal to 55% of the area of the entire touch unit 10.

In the same touch unit 10, an orthographic projection area of the first touch electrode 110 on the substrate is greater than or equal to 35% of the area of the entire touch unit 10 and less than or equal to 45% of the area of the entire touch unit 10.

In the same touch unit 10, an orthographic projection area of the entire floating electrode on the substrate is greater than or equal to 7% of the area of the entire touch unit 10 and less than or equal to 10% of the area of the entire touch unit 10.

Accordingly, in the same touch unit 10, the first electrode region 110a has a larger area, avoiding the situation where the area of the first electrode region 110a is smaller to result in affecting the normal operation of the touch panel 100 due to the first touch electrode 110 being unable to sense and affecting the balance of the overall distal capacitance when a user's finger touches the first electrode region 110a during the operation of the user on the touch panel 100.

### Second Embodiment

As shown in FIG. 8, in this embodiment of the present application, the first touch electrode 110 and the second touch electrode 120 are both I-shaped. Compared with the shape of the touch electrode shown in FIG. 2, in this embodiment, the proportion of the adjacent edges between the first touch electrode 110 and the second touch electrode 120 is smaller, the proximal capacitance is smaller, and the amount of change of the coupling capacitance Cm due to the temperature difference is also smaller, which is conducive to improving the stability of the touch function in high and low temperature environments.

Further, in this embodiment, the region where the touch unit 10 is located is a rectangular region, and the ratio of a length of the touch unit 10 in the first direction to a width of the touch unit 10 in the second direction is between 0.95 and 1.05.

In one embodiment, the length of the touch unit 10 in the first direction is equal to the width of the touch unit 10 in the second direction. With such a design, the touch panel formed by the touch units 10 described above has substantially consistent touch linearity in the first direction and in the second direction, to ensure the touch panel to have substantially the same touch sensitivity in different positions and regions.

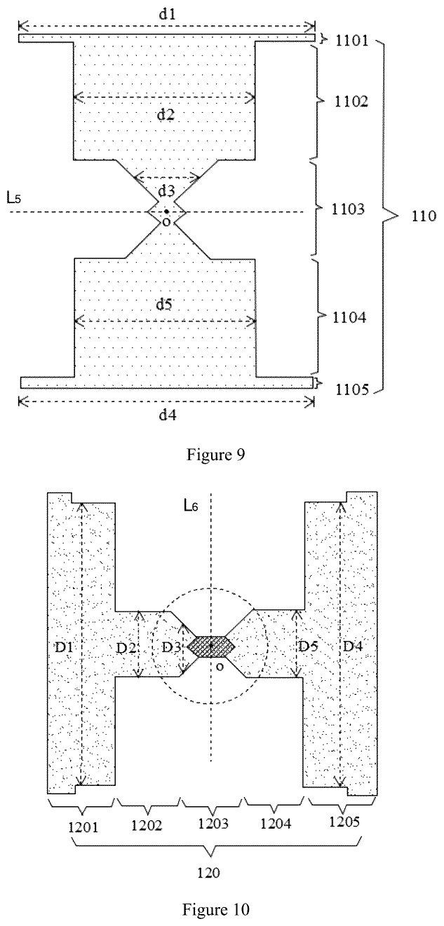

As shown in FIG. 9, in this embodiment of the present application, the first touch electrode 110 includes a first electrode tip 1101, a first electrode middle portion 1102, an electrode connecting portion 1103, a second electrode middle portion 1104 and a second electrode tip 1105 which are connected in sequence in the second direction. A length d1 of the first electrode tip 1101 in the first direction is greater than a length d2 of the first electrode middle portion 1102 in the first direction, the length d2 of the first electrode middle portion 1102 in the first direction is greater than a length d3 of the electrode connecting portion 1103 in the first direction, a length d4 of the second electrode tip 1105 in the first direction is greater than a length d5 of the second electrode middle portion 1104 in the first direction, and the length d5 of the second electrode middle portion 1104 in the first direction is greater than the length d3 of the electrode connecting portion 1103 in the first direction.

As shown in FIG. 10, the second touch electrode 120 includes a third electrode tip 1201, a third electrode middle portion 1202, an electrode overlapping portion 1203, a fourth electrode middle portion 1204 and a fourth electrode tip 1205 which are connected in sequence in the first direction. A width D1 of the third electrode tip 1201 in the second direction is greater than a width D2 of the third electrode middle portion 1202 in the second direction, the width D2 of the third electrode middle portion 1202 in the second direction is greater than a width D3 of the electrode overlapping portion 1203 in the second direction, a width D4 of the fourth electrode tip 1205 in the second direction is greater than a width D5 of the fourth electrode middle portion 1204 in the second direction, and the width D5 of the fourth electrode middle portion 1204 in the second direction is greater than the width D3 of the electrode overlapping portion 1203 in the second direction.

Further, the first touch electrode 110 is symmetrical with respect to a straight line L5 that is across a geometric center O of the electrode connecting portion 1103 and is in the first direction. The length d1 of the first electrode tip 1101 in the first direction is equal to the length d4 of the second electrode tip 1105 in the first direction, and the length d2 of the first electrode middle portion 1102 in the first direction is equal to the length d5 of the second electrode middle portion 1104 in the first direction.

The second touch electrode 120 is axially symmetric with respect to a straight line L6 that is across the geometric center O of the electrode connecting portion 1103 and is in the second direction. The width D1 of the third electrode tip 1201 in the second direction is equal to the width D4 of the fourth electrode tip 1205 in the second direction, and the width D2 of the third electrode middle portion 1202 in the second direction is equal to the width D5 of the fourth electrode middle portion 1204 in the second direction.

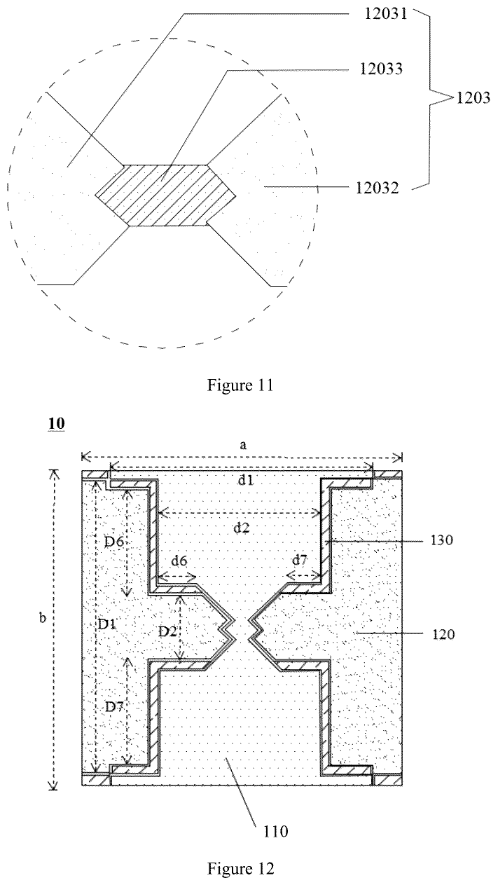

In this embodiment, referring to FIG. 11, the electrode overlapping portion 1203 may include a first electrode overlapping portion 12031 and a second electrode overlapping portion 12032 located on opposite sides of the electrode connecting portion 1103, and a bridging member 12033 configured for connecting the first electrode overlapping portion 12031 and the second electrode overlapping portion 12032. The bridging member 12033 and the electrode connecting portion 1103 are located in different metal layers. The bridging member 12033 may include a plurality of metal wires connected in parallel. In one embodiment, the bridging member 12033 may include four metal wires connected in parallel. The first electrode overlapping portion 12031 and the second electrode overlapping portion 12032 are connected by means of a plurality of metal wires connected in parallel, which can reduce the bridging impedance.

As shown in FIG. 12, in this embodiment of the present application, the length d2 of the first electrode middle portion 1102 in the first direction is 0.4 to 0.6 times a length a of the touch unit, a length d6 of the portion of the first electrode middle portion 1102 adjacent to the third electrode middle portion 1202 in the first direction is 0.1 to 0.15 times the length a of the touch unit, and a length d7 of the portion of the first electrode middle portion 1102 adjacent to the fourth electrode middle portion 1204 in the first direction is 0.1 to 0.15 times the length a of the touch unit.

The width D2 of the third electrode middle portion 1202 in the second direction is 0.16 to 0.3 times a width b of the touch unit 10, a width D6 of the portion of the third electrode tip 1201 adjacent to the first electrode middle portion 1102 in the second direction is 0.3 to 0.4 times the width b of the touch unit, and a width D7 of the portion of the third electrode tip 1201 adjacent to the second electrode middle portion 1104 in the second direction is 0.3 to 0.4 times the width b of the touch unit 10.

With the dimensions designed as above, the first touch electrode 110 and the second touch electrode 120 may have larger electrode areas, which in turn ensures sufficient level of electrode induction.

Further, the length d1 of the first electrode tip 1101 in the first direction is 0.8 to 0.85 times the length a of the touch unit, and the width D1 of the third electrode tip 1201 in the second direction is 0.76 to 0.9 times the width b of the touch unit. The electrode tips designed as above have a large size, and the adjacent touch units 10 can be in full contact when connected by means of the electrode tips, to reduce the connection impedance of the adjacent touch units.

In this embodiment, an area of the first touch electrode 110 accounts for 38% to 43% of an area of the touch unit 10, an area of the second touch electrode 120 accounts for 50% to 55% of the area of the touch unit 10, and an area of the floating electrode 130 accounts for 8% to 11% of the area of the touch unit 10. The floating electrode 130 may have a line width of 110 μm to 150 μm.

In this embodiment, the first touch electrode 110 may be a touch sensing electrode, and the second touch electrode 120 may be a touch driving electrode.

Since the electrode connecting portion 1103 and the electrode overlapping portion 1203 have narrow line widths, providing the floating electrode 130 in the region where the electrode connecting portion 1103 and the electrode overlapping portion 1203 are located will further compress the wiring space of the electrode connecting portion 1103 and the electrode overlapping portion 1203 to increase the connection impedance in this region. To this end, in this embodiment, there may be no floating electrode 130 distributed between the electrode connecting portion 1103 and the electrode overlapping portion 1203, and a width of the gap between the electrode connecting portion 1103 and the electrode overlapping portion 1203 may be 0.1 to 0.15 times the length a of the touch unit 10.

The touch unit according to the embodiments of the present application includes a first touch electrode, a second touch electrode and a floating electrode which are insulated from each other, and the floating electrode is disposed in at least part of the region between the first touch electrode and the second touch electrode. In this way, the distance between the adjacent first touch electrode and second touch electrode can be increased, and the proximal capacitance between the first touch electrode and the second touch electrode can be reduced. Since the dielectric coefficient due to temperature difference greatly affects the proximal capacitance, reducing the proximal capacitance can reduce the amount of change of the coupling capacitance due to temperature difference, thereby improving the stability of the touch function in high and low temperature environments.

Moreover, the touch panel according to the embodiments of the present application includes the touch unit described above. Using the touch unit described above can ensure the stability of the touch function of the touch panel under conditions of large temperature difference, thereby improving the user experience and product market competitiveness.

The foregoing descriptions are merely specific implementations of the present application, but the scope of protection of the present application is not limited thereto. Any changes or substitutions readily conceivable in the art within the scope disclosed in the present application shall be covered within the scope of protection of the present application. Accordingly, the scope of protection of the present application shall be based on the scope of protection of the claims.

1. A touch panel, comprising a substrate and a plurality of touch units, wherein
the plurality of touch units are arranged in an array on the substrate, and each of the touch units comprises a first touch electrode and at least one second touch electrode insulated from each other; and
in the same touch unit, the first touch electrode and the second touch electrode has an isolation gap defined therebetween, at least part of the isolation gap has a floating electrode formed therein, and the floating electrode is insulated from both the first touch electrode and the second touch electrode.

2. The touch panel according to claim 1, wherein each of the touch units comprises two second touch electrodes; and
the first touch electrode is disposed between the two second touch electrodes, and the two second touch electrodes are electrically connected to each other.

3. The touch panel according to claim 2, wherein the two second touch electrodes are arranged on two sides of the first touch electrode in a first direction;
in the same touch unit, the first touch electrode comprises a first electrode region and two second electrode regions;
the two second electrode regions are respectively located on two sides of the first electrode region in a second direction, and the first direction intersects with the second direction; and
the floating electrode is provided in the isolation gaps between the first electrode region and the second touch electrode and between the second electrode region and the second touch electrode.

4. The touch panel according to claim 3, wherein the touch unit further comprises a bridge connecting the two second touch electrodes; and
the bridge is disposed at a connection between the first electrode region and the second electrode region.

5. The touch panel according to claim 3, wherein in the same touch unit, the size of the first electrode region in the first direction increases and then decreases in the second direction; and
in the same touch unit, the size of the second electrode region in the first direction gradually decreases in a direction from the second electrode region to the first electrode region.

6. The touch panel according to claim 2, wherein edges of the isolation gap form boundaries with the first touch electrode and the second touch electrode, respectively;
an extension direction of the floating electrode is consistent with an extension direction of the boundaries, and two sides of the floating electrode form insulation gaps with the first touch electrode and the second touch electrode, respectively, in an extension direction perpendicular to the boundaries; and
the floating electrode comprises a plurality of sub-electrodes arranged in sequence and spaced apart from each other in the extension direction of the boundaries.

7. The touch panel according to claim 6, wherein two second touch electrodes located in a same touch unit are symmetrically arranged on two sides of the first touch electrode in the first direction;
one side of the edge of the isolation gap and the second touch electrode form an M-shaped boundary, and the other side of the isolation gap and the first touch electrode form an M-shaped boundary; and
a bridge is provided between vertices, close to each other, of the M-shaped boundaries of the two second touch electrodes.

8. The touch panel according to claim 7, wherein the M-shaped boundary formed by the second touch electrode comprises a first border, a second border, a third border and a fourth border which are connected in sequence in the second direction;
the first border, the second border, the third border and the fourth border are each configured as a straight-line segment; and
each of the borders is formed with one of the sub-electrodes, and the one of the sub-electrodes is a linear electrode.

9. The touch panel according to claim 1, wherein the touch unit comprises the first touch electrode and the second touch electrode which are both I-shaped; and
wherein the entirety of the first touch electrode extends in the first direction, the entirety of the second touch electrode extends in the second direction, and the first direction is perpendicular to the second direction.

10. The touch panel according to claim 9, wherein the first touch electrode comprises a first electrode tip, a first electrode middle portion, an electrode connecting portion, a second electrode middle portion and a second electrode tip which are connected in sequence in the second direction;
lengths of the first electrode tip, the first electrode middle portion and the electrode connecting portion in the first direction decrease in sequence, and lengths of the second electrode tip, the second electrode middle portion and the electrode connecting portion in the first direction decrease in sequence;
the second touch electrode comprises a third electrode tip, a third electrode middle portion, an electrode overlapping portion, a fourth electrode middle portion and a fourth electrode tip which are connected in sequence in the first direction; and
widths of the third electrode tip, the third electrode middle portion and the electrode overlapping portion in the second direction decrease in sequence, and widths of the fourth electrode tip, the fourth electrode middle portion and the electrode overlapping portion in the second direction decrease in sequence.

11. The touch panel according to claim 10, wherein the electrode overlapping portion comprises a first electrode overlapping portion and a second electrode overlapping portion located on opposite sides of the electrode connecting portion, and a bridging member connecting the first electrode overlapping portion and the second electrode overlapping portion; and
the bridging member comprises a plurality of metal wires connected in parallel, and the bridging member and the electrode connecting portion are located in different metal layers.

12. The touch panel according to claim 10, wherein the first touch electrode is axially symmetric with respect to a straight line that is across a geometric center of the electrode connecting portion and is in the first direction; and
the second touch electrode is axially symmetric with respect to a straight line that is across the geometric center of the electrode connecting portion and is in the second direction.

13. The touch panel according to claim 1, wherein a ratio of a length of the touch unit in the first direction to a length of the touch unit in the second direction is greater than or equal to 0.95 and less than or equal to 1.05.

14. The touch panel according to claim 1, wherein a region where the touch unit is located is a rectangular region;
in the same touch unit, an orthographic projection area of the entire first touch electrode on the substrate is greater than or equal to 45% of an area of the entire touch unit and less than or equal to 55% of the area of the entire touch unit.

15. The touch panel according to claim 1, wherein in the same touch unit, an orthographic projection area of the second touch electrode on the substrate is greater than or equal to 35% of the area of the entire touch unit and less than or equal to 45% of the area of the entire touch unit, wherein
in the same touch unit, an orthographic projection area of the entire floating electrode on the substrate is greater than or equal to 7% of the area of the entire touch unit and less than or equal to 11% of the area of the entire touch unit.

16. A display device, comprising a touch panel, comprising:
a substrate and a plurality of touch units, wherein
the plurality of touch units are arranged in an array on the substrate, and each of the touch units comprises a first touch electrode and at least one second touch electrode insulated from each other; and
in the same touch unit, the first touch electrode and the second touch electrode has an isolation gap defined therebetween, at least part of the isolation gap has a floating electrode formed therein, and the floating electrode is insulated from both the first touch electrode and the second touch electrode.

17. The display device according to claim 16, wherein each of the touch units comprises two second touch electrodes; and
the first touch electrode is disposed between the two second touch electrodes, and the two second touch electrodes are electrically connected to each other.

18. The display device according to claim 17, wherein the two second touch electrodes are arranged on two sides of the first touch electrode in a first direction;
in the same touch unit, the first touch electrode comprises a first electrode region and two second electrode regions;
the two second electrode regions are respectively located on two sides of the first electrode region in a second direction, and the first direction intersects with the second direction; and
the floating electrode is provided in the isolation gaps between the first electrode region and the second touch electrode and between the second electrode region and the second touch electrode.

19. The display device according to claim 18, wherein the touch unit further comprises a bridge connecting the two second touch electrodes; and
the bridge is disposed at a connection between the first electrode region and the second electrode region.

20. The display device according to claim 19, wherein in the same touch unit, the size of the first electrode region in the first direction increases and then decreases in the second direction; and
in the same touch unit, the size of the second electrode region in the first direction gradually decreases in a direction from the second electrode region to the first electrode region.
